(19) United States
(12) Patent Application Publication
(10) Pub. No.: US 2015/0020959 A1
(43) Pub. Date: Jan. 22, 2015

(54) MULTI-LAYER 3D PATTERN MANUFACTURING METHOD AND MANUFACTURING APPARATUS THEREOF

(71) Applicant: SUNTEK PRECISION CORP., NEW TAIPEI CITY (TW)

(72) Inventor: CHIEN-MIN CHANG, NEW TAIPEI CITY (TW)

(21) Appl. No.: 13/944,854

(22) Filed: Jul. 17, 2013

(51) Int. Cl. B32B 37/00; B32B 37/10; B32B 38/14; B32B 38/04; B32B 38/06; B32B 37/12; B32B 38/00

(52) U.S. Cl. CPC B32B 37/025; B32B 37/12; B32B 37/10; B32B 38/0012; B32B 38/04; B32B 38/06; B32B 38/14; B32B 2037/1253; B32B 2038/042
USPC 156/219; 156/379.6

(57) ABSTRACT

A multi-layer 3D pattern manufacturing method includes the steps of forming a color film on a surface of a substrate or a third pattern structure by providing a chromogenic material by lithography, gravure, flexographic printing, screen printing and physical vapor deposition in a transcribed printing process. Using the color film to match with different 3D pattern structures to form a multilayer 3D pattern which can be applied to the housing of various different electronic products not only can improve the aesthetic appearance, it can also enclose the color film within the 3D pattern to prevent the 3D pattern from falling off or fading; thus, the lifetime of the pattern can be improved.

### BACKGROUND OF THE INVENTION

1. Field of the Invention

The present invention generally relates to the field of pattern transfer printing on a substrate surface, in particular to a multi-layer 3D pattern manufacturing method and a manufacturing apparatus thereof

2. Description of the Related Art

As science and technology advance, various 3C products including Smartphones, tablet PCs and notebook computers are introduced into the market. Particularly, the Smartphones and tablet PCs integrated with wireless network and mobile network allow people to obtain the latest information anywhere anytime, so that the use of Smartphones or tablet PCs has become an indispensable part of our daily life.

To pursue the visual aesthetic appearance, decorations including patterns or colors are generally added to the housing of the 3C products or materials such as leather or silicone are used to create the visual aesthetic look of the conventional 3C products. Since most of the housings are made of material, therefore 3D patterns can be directly manufactured on the surface of the 3C products by plastic injection molding. On the other hand, 2D patterns or color decorations can be made by bake painting or spraying, not only causing pollutions, but also requiring a secondary process to assure the durability of the product and prevent the patterns or colors from falling off or fading.

In addition, conventional manufacturing technologies or metal surface processing technologies including chemical coloring, electrolytic coloring, decorative coloring and metal surface etching technologies of the 3C products with a metal housing are limited, and thus having a high cost and the difficulty of improving the aesthetic appearance of the products. Most of the aforementioned surface decoration and processing technologies just can provide a planar decoration and processing of the surface of the housing, but they cannot achieve the 3D decorative effect or satisfy the user requirement for the aesthetic appearance of the products.

Therefore, the inventor of the present invention invented an UV light curing 3D graphic transcription method as disclosed in. With reference to FIG. 1 for the transcription method of R.O.C. Pat. No. 1385078, the method comprises the following steps:

S11: Provide a mother board processed by an anti-adhesion treatment and having a first graphic structure.

S12: Provide a sub-film coated with a first light curing adhesive.

S13: Roll and laminate the sub-film with the mother board to permeate the first light curing adhesive into the first graphic structure.

S14: Cure the first light curing adhesive with light and fowl a second graphic structure on the sub-film.

S15: De-mold the sub-film and the mother board.

S16: Provide a substrate coated with a second light curing adhesive.

S17: Bake the substrate.

S18: Transcribe the second graphic structure to the substrate, so that a third graphic structure is formed on the substrate, while simultaneously light curing the second light curing adhesive.

S19: Process the substrate with illumination, so that a 3D graphic pattern is formed on a surface of the substrate to improve the aesthetic appearance.

However, the inventor of the present invention further improves the foregoing patented invention by combining colors to the original UV light curing 3D graphic transcription method of producing 3D patterns and provides a manufacturing method for showing a multi-layer 3D pattern and improving the aesthetic look and durability significantly.

### SUMMARY OF THE INVENTION

Therefore, it is a primary objective of the present invention to provide a multi-layer 3D pattern manufacturing method and a manufacturing apparatus thereof to cover a color film by a 3D pattern structure and change the original 3D pattern structure into a multi-layer structure, so as to achieve the effect of improving the aesthetic look of the substrate. In the meantime, the color film is protected by the 3D pattern structure to prevent the color film from falling off or fading, so as to enhance the durability significantly.

To achieve the foregoing objective, the present invention provides a preferred embodiment of a multi-layer 3D pattern manufacturing method, comprising the steps of: providing a mother board, a sub-film and a substrate, wherein the mother board is processed with an anti-adhesion treatment and has a first pattern structure, and the sub-film is a translucent material with a side coated with a first light curing adhesive; rolling and laminating the sub-film with the mother board, and forming a second pattern structure onto the sub-film after the transcribed printing and the light curing take place sequentially; de-molding the sub-film and the mother board; providing a chromogenic material, and forming a color film on a surface of the substrate; coating a second light curing adhesive on the color film; transferring and printing the second pattern structure onto the second light curing adhesive, such that the color film is included between the substrate and the second light curing adhesive, while simultaneously light curing the second light curing adhesive to form a third pattern structure with a multi-layer pattern; providing a mold, and heating the substrate simultaneously, so that the substrate and the third pattern structure are extensible; using the mold to punch and shape the substrate and the third pattern structure, so that the extensible substrate and third pattern structure will not be cracked by punching; and processing the substrate with an illumination treatment.

In another a preferred embodiment of the present invention, the multi-layer 3D pattern manufacturing method comprises the steps of: providing a mother board, a sub-film and a substrate, wherein the mother board is processed with an anti-adhesion treatment and has a first pattern structure, and the sub-film is a translucent material having a side coated with a first light curing adhesive and the other side coated with a second light curing adhesive; rolling and laminating the sub-film with the mother board, and forming a second pattern structure on the sub-film after the transfer printing and the light curing steps take place sequentially; de-molding the sub-film and the mother board; transfer-printing the second pattern structure onto the second light curing adhesive, while simultaneously light curing the second light curing adhesive to from a third pattern structure; providing a chromogenic material, and forming a color film onto the third pattern structure; coating a third light curing adhesive onto the color film; transcribing and printing the second pattern structure onto the third light curing adhesive, so that the color film is included between the third pattern structure and the third light curing adhesive, while simultaneously light curing the third light curing adhesive to form a fourth pattern structure with a multi-layer pattern; providing a mold, while simultaneously heating the substrate, so that the substrate and the fourth pattern structure are extensible; using the mold to punch and shape the substrate, the third pattern structure and the fourth pattern structure, so that the extensible substrate, third pattern structure and fourth pattern structure will not be cracked by punching; and processing the substrate with an illumination treatment.

Experiments show that the transcription rate of the aforementioned two preferred embodiments is up to 1:0.99, and the present invention further heats up to an appropriate temperature during the punching and shaping processes in order to prevent the substrate from being cracked by punching.

Wherein, the first pattern structure is manufactured by a process selected from the group of etch molding, laser engraving, drill molding, and sand-blast molding, and patterns with different depths, widths, intervals, surface glosses (roughness) and angles can be produced to meet the pattern effect and requirement for different applications.

In addition, the step of providing a chromogenic material, and forming a color film on a surface of the substrate is achieved by a method selected from the group of lithography, gravure, flexographic printing, screen printing and physical vapor deposition, and the chromogenic material used in the physical vapor deposition method is one selected from the group of nitrate, carbide, carbonitride, oxide and nitrogen oxide. With these chromogenic materials, different colors such as brown, yellow, green, gray, dark blue, gold, light gray, dark gray, black, purple and dark green can be produced, and these colors are helpful in layering and color mixing applications.

The aforementioned two preferred embodiments adopt a multi-layer 3D pattern manufacturing apparatus, comprising: a carrying platform, having a ridge formed separately on both lateral edges of the carrying platform and corresponding to the thickness of the substrate and the sub-film, and the two ridges being disposed parallel to each other to form a rail, and the substrate and the sub-film being disposed between the rail; a heating module, installed in the carrying platform, for heating the substrate to 60 degrees-300 degrees Celsius; a transfer printing module, installed at the top of the carrying platform, and having a roller and an UV illuminating unit, and a predetermined interval being form between the roller and the rail for accommodating the substrate and the sub-film, and the roller uniformly pressing the sub-film on the substrate for transcribing and printing; a substrate fixture, having a fixed clamping unit and a movable clamping unit, and the fixed clamping unit being installed on a side of the carrying platform, and the movable clamping unit being installed on the other side of the carrying platform, and the fixed clamping unit and the movable clamping unit clamping both ends of the demolded sub-film; and an ejector, installed between the carrying platform and the movable clamping unit, such that when the roller presses the sub-film down to the substrate, the movable clamping unit is driven by the sub-film to move downwardly, and when the ejector moves upward, the movable clamping unit is driven by the sub-film to move upwardly in a direction towards the carrying platform.

Wherein, the predetermined interval is achieved by adjusting the height of the pair of ridges and the downward pressure of the roller to improve the transcription rate.

### BRIEF DESCRIPTION OF THE DRAWINGS

FIG. 1 is a flow chart of R.O.C. Pat. No. 1385078;

FIG. 2 is a flow chart of a first preferred embodiment of the present invention;

FIG. 3 is a schematic view of the first preferred embodiment of the present invention;

FIGS. 4A and 4B are flow charts of second preferred embodiment of the present invention;

FIG. 5 is a schematic view of the second preferred embodiment of the present invention;

FIG. 6 is a schematic perspective view of a manufacturing apparatus of a preferred embodiment of the present invention; and

FIG. 7 is a partial schematic view of a carrying platform of a preferred embodiment of the present invention.

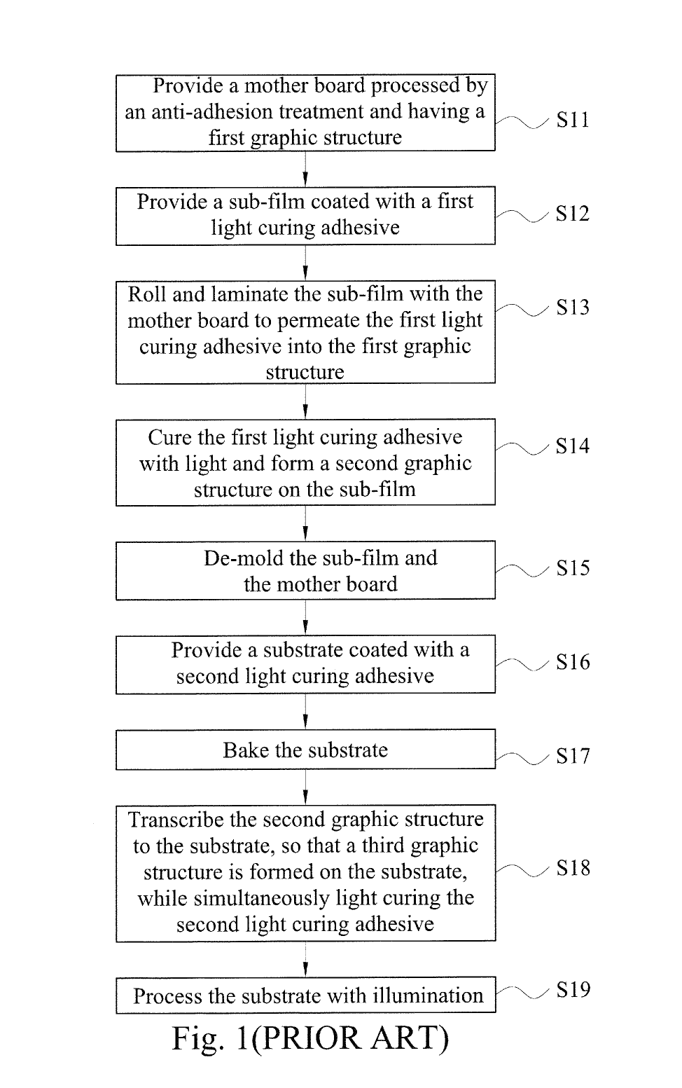

### DETAILED DESCRIPTION OF THE PREFERRED EMBODIMENTS

The technical content of the present invention will become apparent by the detailed description of the following embodiments and the illustration of related drawings as follows.

### First Preferred Embodiment

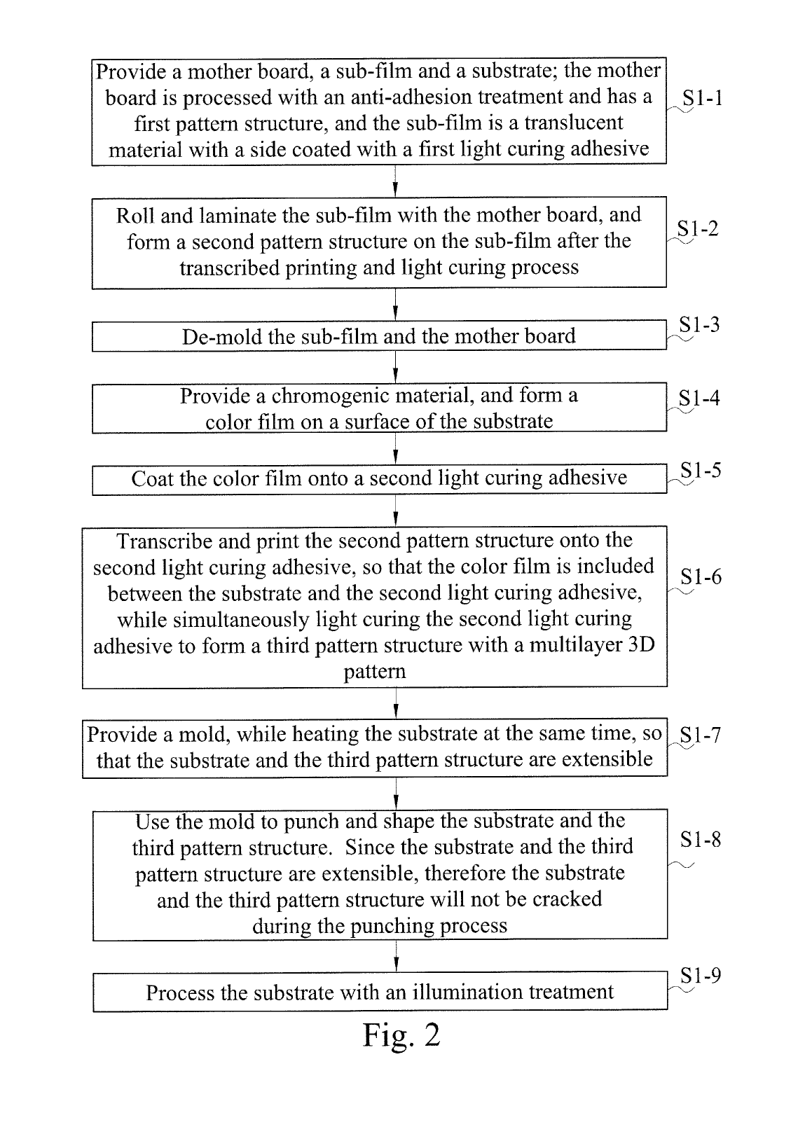

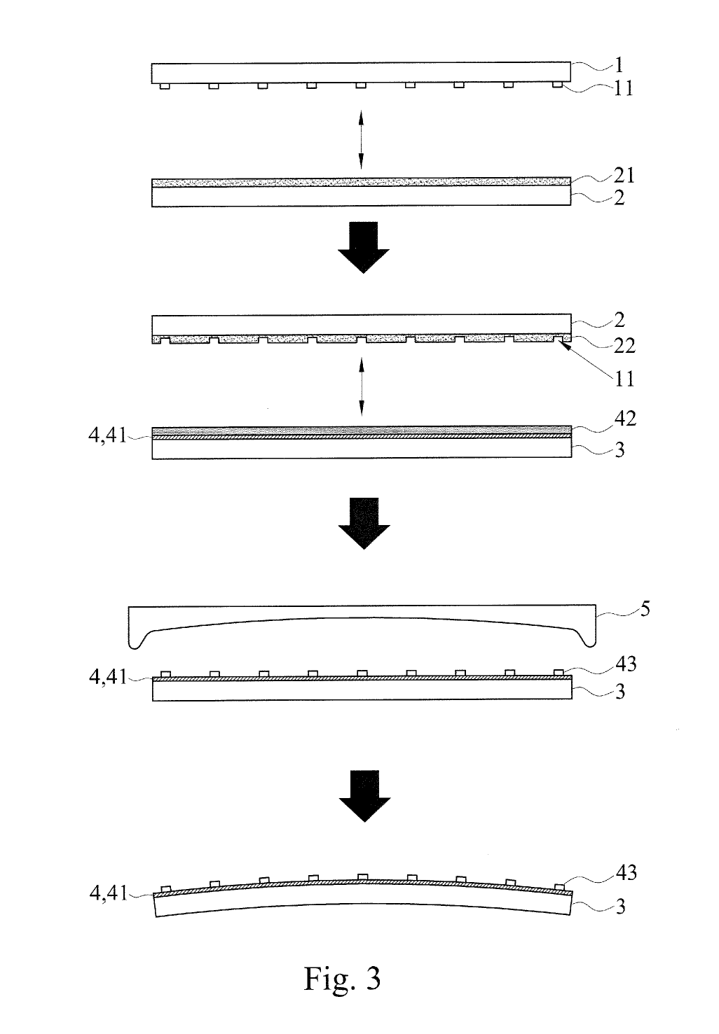

With reference to FIGS. 2 and 3 for a flow chart and a schematic view of the first preferred embodiment of the present invention respectively, a multi-layer 3D pattern manufacturing method of the first preferred embodiment of the present invention comprises the following steps:

S1-1: Provide a mother board 1, a sub-film 2 and a substrate 3, wherein the mother board 1 is processed with an anti-adhesion treatment and has a first pattern structure 11, and the sub-film 2 is a translucent material with a side coated with a first light curing adhesive 21. It is noteworthy that the mother board 1 is a flat board made of material selected from anyone of stainless steel, electroformed plate and quartz glass. And the first pattern structure 11 of the mother board 1 is manufactured by methods such as etch molding, laser engraving, drill molding, or sand-blast molding to create patterns with different depths, widths, intervals, surface glosses (roughness) and angles to meet the pattern effect and requirements for different applications.

As shown in Table 1, the sub-film 2 is a film made of a plastic material selected from polycarbonate (PC), poly(methyl methacrylate) (PMMA) or polyethylene terephthalate (PET).

TABLE 1

| | | Laser | Drill | |
|---|---|---|---|---|
| Process | Etch Molding | Engraving | Molding | Sand-blast Molding |
| Description | Mask with an | Mask with an | Engrave a | Mask with a |
| | acid-resisting | acid-resisting | pattern by | sand-blast resisting |
| | photomask to | photomask to | a diamond | photomask to print |
| | develop a | etch a pattern | cutter and | a pattern and create |
| | pattern from a | by laser. Dip a | a CNC | a surface of |
| | film. Dip a mold | mold in an acid | process | different textures |
| | in an acid to | to etch to a | | by different sand |
| | etch to a desired | desired depth. | | sizes and pressures. |
| | depth. | | | |
| Pattern Depth | <500μ | ≦50μ | ≦15μ | ≦20μ |
| Pattern Width | >50μ | >100μ | ≦50μ | ≦200μ |
| Pattern Interval | ≧100μ | ≦500μ | ≦50μ | ≦200μ |
| Surface Gloss | 10°~60° | 10°~60° | 60°~120° | 10°~90° |
| Angle | <90° | <90° | <90° | N/A |

S1-2: Roll and laminate the sub-film 2 with the mother board 1, and form a second pattern structure 22 on the sub-film 2 after the transcribed printing and the light curing take place sequentially.

S1-3: De-mold the sub-film 2 and the mother board 1, and the second pattern structure 22 stays on a surface of the sub-film 2 after the sub-film 2 and the mother board 1 are demolded.

S1-4: Provide a chromogenic material 4, and form a color film 41 on a surface of the substrate 3. It is noteworthy that the chromogenic material 4 is manufactured by a method such as lithography, gravure, flexographic printing, screen printing and physical vapor deposition. Particularly, when the physical vapor deposition method is adopted, the chromogenic material 4 is one selected from the group of nitrate, carbide, carbonitride, oxide and nitrogen oxide to result in different colors as listed in Table 2.

TABLE 2

| TYPE | COMPOUND | COLOR |
|---|---|---|
| Nitrides | TiN | Golden-->brown-yellow |
| | ZrN | Yellow-->green |
| | Cr2N, CrN | Metallic-->brown |
| | TaN | Blue-->grey |
| | (Ti, Al)N | Gold-->dark blue |
| | (Ti, Zr)N | Golden |
| Carbides | TiC | Bright grey |
| | TiC/Nc | Dark Grey |
| | TaCx | Yellow-->brown |
| | SiC | Black |
| Carbonitrides | TiCxNy | Red golden-->violet |
| | ZrCxNy | Silver-->gold-->violet |
| | (Ti, AlCxNy | Purple |
| Oxides | TiO2 | Light grey-->blue |
| | CrxOy | Copper-->dark green |
| Oxinitrides | (Ti, Al)OxNy | Brown-->dark blue |
| | TiOxNy | Transparent-->black |

S1-5: Coat the color film 41 onto a second light curing adhesive 42.

S1-6: Transcribe and print the second pattern structure 22 onto the second light curing adhesive 42, so that the color film 41 is included between the substrate 3 and the second light curing adhesive 42, while simultaneously light curing the second light curing adhesive 42 to form a third pattern structure 43 with a multilayer 3D pattern. Wherein, the third pattern structure 43 together with the color film 41 are fixed onto a surface of the substrate 3.

S1-7: Provide a mold 5, while heating the substrate 3 at the same time, so that the substrate 3 and the third pattern structure 43 are extensible.

S1-8: Use the mold 5 to punch and shape the substrate 3 and the third pattern structure 43. Since the substrate and the third pattern structure 43 are extensible, therefore the substrate 3 and the third pattern structure 43 will not be cracked during the punching process.

S1-9: Process the substrate 3 with an illumination treatment.

### Second Preferred Embodiment

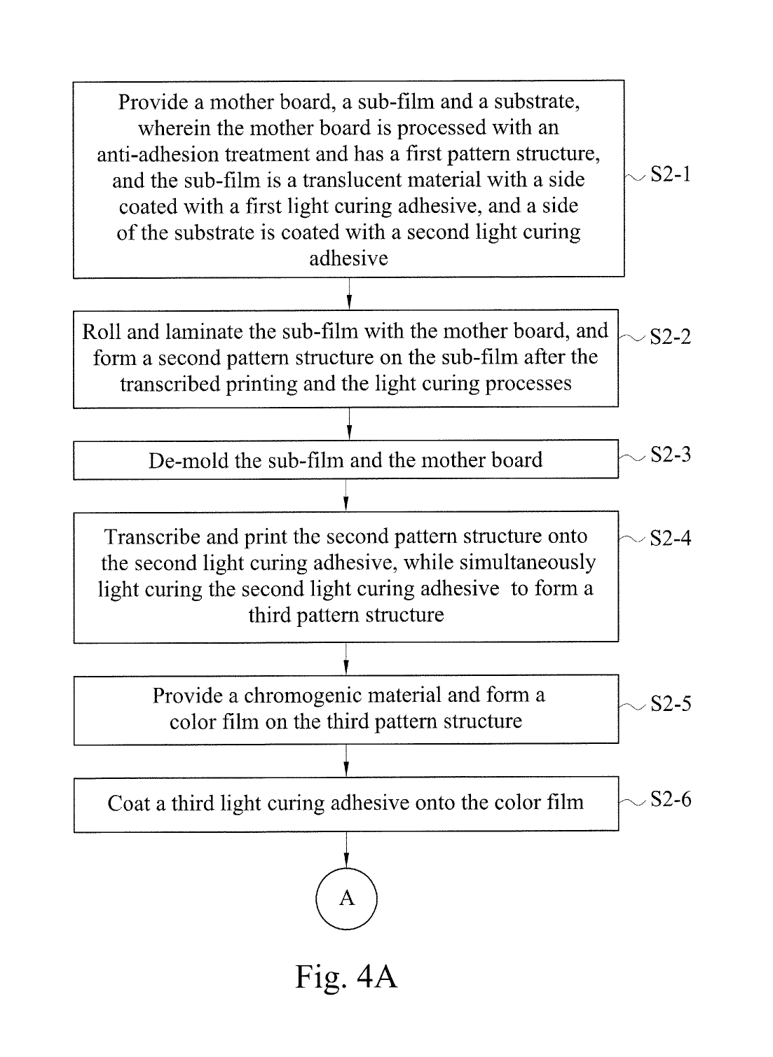

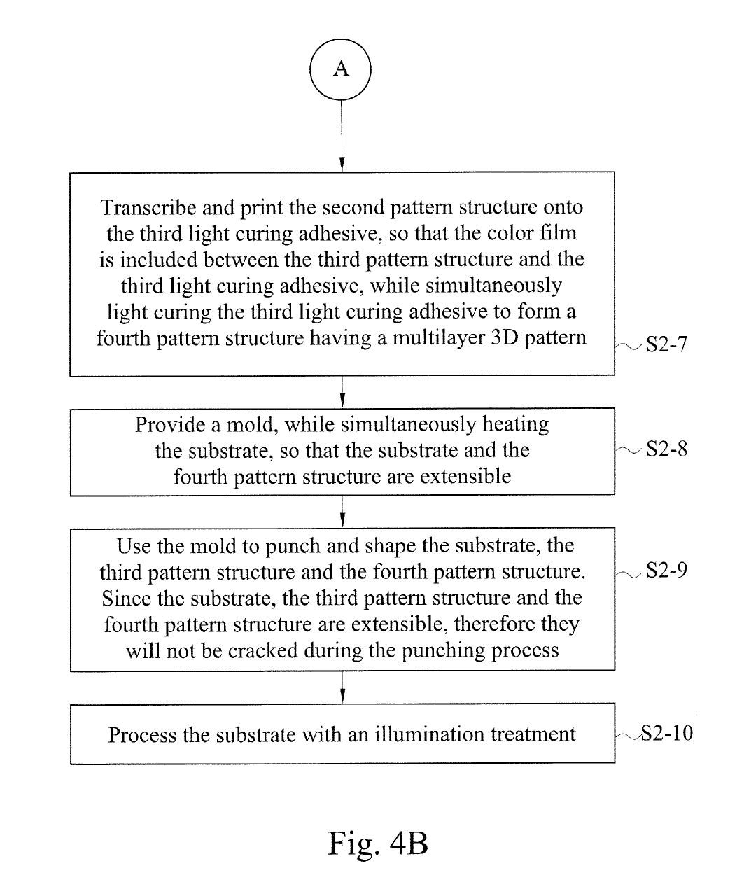

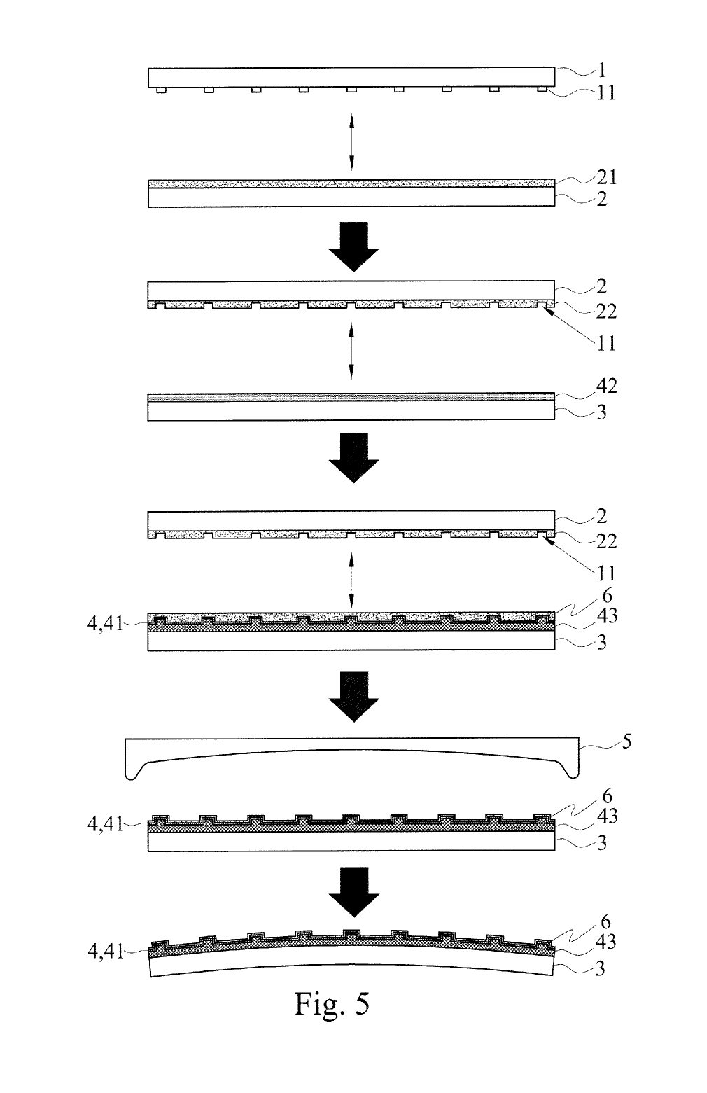

With reference to FIGS. 4A, 4B and 5 for a flow chart and a schematic view of the second preferred embodiment of the present invention respectively, the materials used in the multi-layer 3D pattern manufacturing method of the second preferred embodiment of the present invention are the same as those of the first preferred embodiment, but the steps are slightly different, so that the same numerals are the same elements in both embodiments. The multi-layer 3D pattern manufacturing method of the second preferred embodiment of the present invention comprises the following steps:

S2-1: Provide a mother board 1, a sub-film 2 and a substrate 3, wherein the mother board 1 is processed with an anti-adhesion treatment and has a first pattern structure 11, and the sub-film 2 is a translucent material with a side coated with a first light curing adhesive 21, and a side of the substrate 3 is coated with a second light curing adhesive 42.

S2-2: Roll and laminate the sub-film 2 with the mother board 1, and form a second pattern structure 22 on the sub-film 2 after the transcribed printing and the light curing take place sequentially.

S2-3: De-mold the sub-film 2 and the mother board 1.

S2-4: Transcribe and print the second pattern structure 22 onto the second light curing adhesive 42, while simultaneously light curing the second light curing adhesive 42 to form a third pattern structure 43.

S2-5: Provide a chromogenic material 4 and form a color film 41 on the third pattern structure 43.

S2-6: Coat a third light curing adhesive 6 onto the color film 41.

S2-7: Transcribe and print the second pattern structure 22 onto the third light curing adhesive 6, so that the color film 41 is included between the third pattern structure 43 and the third light curing adhesive 6, while simultaneously light curing the third light curing adhesive 6 to form a fourth pattern structure 61 having a multilayer 3D pattern.

S2-8: Provide a mold 5, while simultaneously heating the substrate 3, so that the substrate 3 and the fourth pattern structure 61 are extensible.

S2-9: Use the mold 5 to punch and shape the substrate 3, the third pattern structure 43 and the fourth pattern structure 61. Since the substrate 3, the third pattern structure 43 and the fourth pattern structure 61 are extensible, therefore they will not be cracked during the punching process.

S2-10: Process the substrate 3 with an illumination treatment.

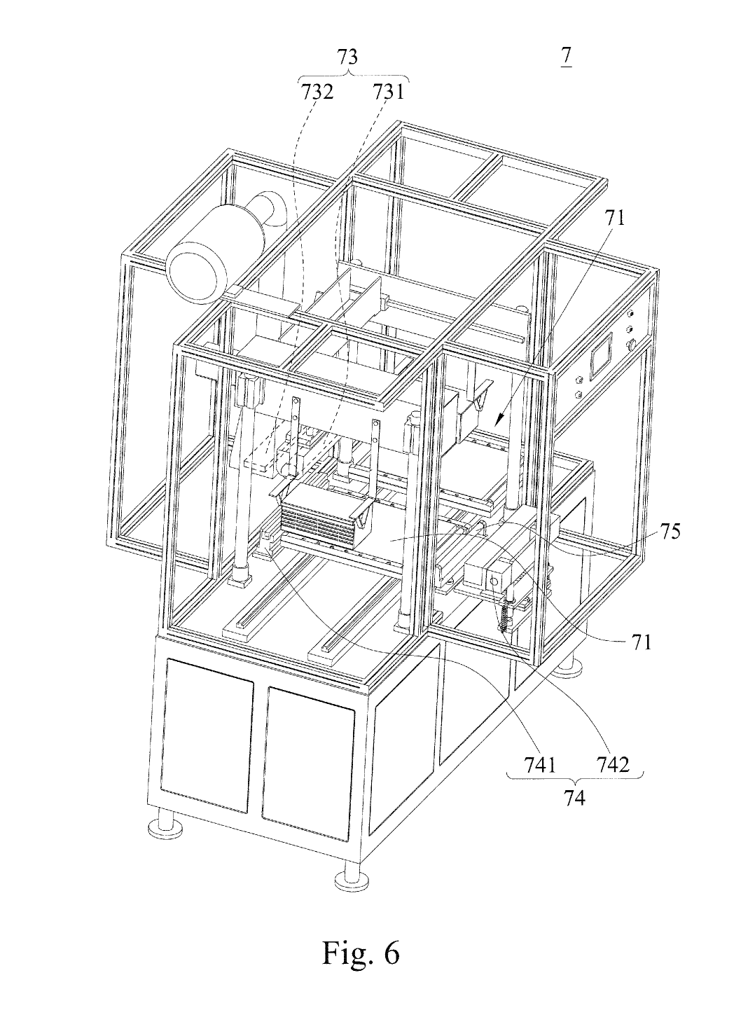

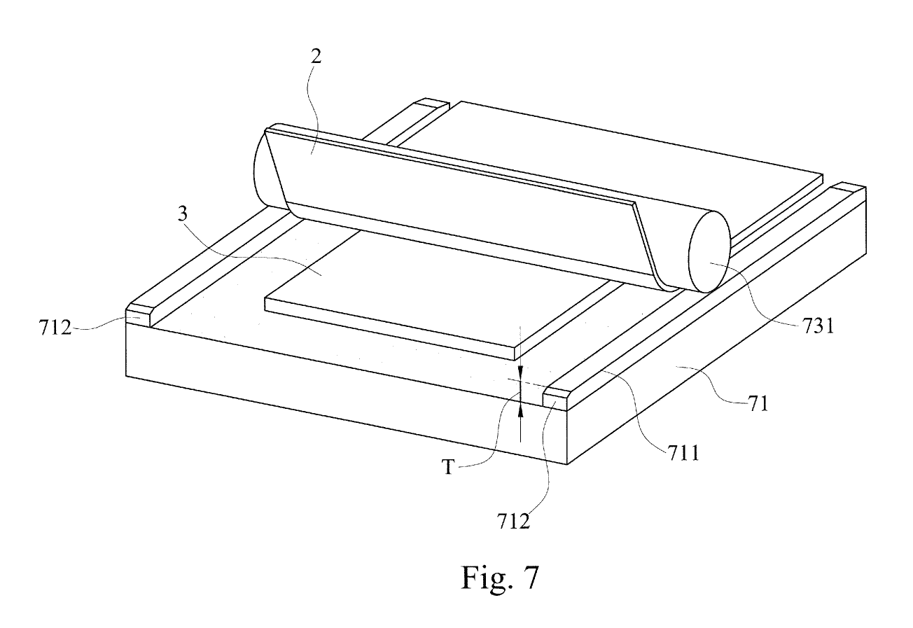

With reference to FIGS. 6 and 7 for a schematic perspective view of a manufacturing apparatus and a schematic view of a carrying platform of a preferred embodiment of the present invention respectively, the manufacturing apparatus 7 used in the foregoing two preferred embodiment comprises a carrying platform 71, a heating module 72, a transfer printing module 73, a substrate fixture 74 and an ejector 75.

The carrying platform 71 has a ridge 711 formed separately on both sides of the carrying platform 71, and the ridges 711 are disposed parallel to each other to form a rail 712, and the height of the rail 712 is corresponsive to the thickness of the substrate 3 and the sub-film 2 for disposing the substrate 3 and the sub-film 2 in the rail 712.

The heating module 72 is installed inside the carrying platform 71 for heating the substrate 3 to 60-300° C.

The transfer printing module 73 is installed at the top of the carrying platform 71, and the transfer printing module 73 has a roller 731 and an UV illuminating unit 732, and a predetermined interval T is formed between the roller 731 and the rail 712 for accommodating the substrate 3 and the sub-film 2, and the roller 731 uniformly presses the sub-film 2 at the substrate 3 to perform the transcribed printing process. In addition, the predetermined interval T can be achieved by adjusting the height of the pair of the ridges 711 and the downward pressure of the roller 731, so that the sub-film 2 or the substrate 3 with a different thickness can be used to improve the transcription rate.

The substrate fixture 74 has a fixed clamping unit 741 and a movable clamping unit 742, wherein the fixed clamping unit 741 is installed on a side of the carrying platform 71, and the movable clamping unit 742 is installed on the other side of the carrying platform 71, and both ends of the sub-film 2 are clamped by the fixed clamping unit 741 and the movable clamping unit 742 respectively.

The ejector 75 is installed between the carrying platform 71 and the movable clamping unit 742. When the roller 731 presses the sub-film 2 down to the substrate 3, the movable clamping unit 742 is driven by the sub-film 2 to move downward. When the ejector 75 moves upwardly, the movable clamping unit 742 is driven by the sub-film 2 to move upwardly in a direction towards the carrying platform 71.

While the invention has been described by means of specific embodiments, numerous modifications and variations could be made thereto by those skilled in the art without departing from the scope and spirit of the invention set forth in the claims.

What is claimed is:

1. A multi-layer 3D pattern manufacturing method, comprising:
providing a mother board, a sub-film and a substrate, wherein the mother board is processed with an anti-adhesion process and has a first pattern structure, and the sub-film is made of a translucent material and has a first light curing adhesive coated on a side of the sub-film;
rolling and laminating the sub-film with the mother board, and then forming a second pattern structure on the sub-film after a transcribed printing process and a light curing process;
de-molding the sub-film and the mother board;
providing a chromogenic material, and forming a color film on a surface of the substrate;
coating a second light curing adhesive on the color film;
transferring and printing the second pattern structure onto the second light curing adhesive, such that the color film is included between the substrate and the second light curing adhesive, while simultaneously light curing the second light curing adhesive to form a third pattern structure having a multi-layer pattern;
providing a mold, and heating the substrate simultaneously, so that the substrate and the third pattern structure are extensible;
using the mold to punch and shape the substrate and the third pattern structure, and the extensible substrate and third pattern structure will not be cracked by punching; and
processing the substrate with an illumination treatment.

2. The multi-layer 3D pattern manufacturing method of claim 1, wherein the first pattern structure is manufactured by a process selected from the group of etch molding, laser engraving, drill molding, and sand-blast molding.

3. The multi-layer 3D pattern manufacturing method of claim 1, wherein the step of providing a chromogenic material, and forming a color film on a surface of the substrate is achieved by a method selected from the group of lithography, gravure, flexographic printing, screen printing and physical vapor deposition.

4. The multi-layer 3D pattern manufacturing method of claim 3, wherein the chromogenic material used in the physical vapor deposition method is one selected from the group of nitrate, carbide, carbonitride, oxide and nitrogen oxide.

5. A multi-layer 3D pattern manufacturing method, comprising:
providing a mother board, a sub-film and a substrate, wherein the mother board is processed with an anti-adhesion treatment and having a first pattern structure, the sub-film is made of a translucent material, and a first light curing adhesive is coated on a side of the sub-film, and a second light curing adhesive is coated on a side of the substrate;
rolling and laminating the sub-film with the mother board, and forming a second pattern structure on the sub-film after a transfer printing process and a light curing process;
de-molding the sub-film and the mother board;
transfer-printing the second pattern structure onto the second light curing adhesive, while simultaneously light curing the second light curing adhesive to from a third pattern structure;
providing a chromogenic material, and forming a color film onto the third pattern structure;
coating a third light curing adhesive onto the color film;
transcribing and printing the second pattern structure onto the third light curing adhesive, so that the color film is included between the third pattern structure and the third light curing adhesive, while simultaneously light curing the third light curing adhesive to form a fourth pattern structure with a multi-layer 3D pattern;
providing a mold, while simultaneously heating the substrate, so that the substrate and the fourth pattern structure are extensible;
using the mold to punch and shape the substrate, the third pattern structure and the fourth pattern structure, and the extensible substrate, the third pattern structure and the fourth pattern structure will not be cracked by punching; and
processing the substrate with an illumination treatment.

6. The multi-layer 3D pattern manufacturing method of claim 5, wherein the first pattern structure is manufactured by a process selected from the group of etch molding, laser engraving, drill molding, and sand-blast molding.

7. The multi-layer 3D pattern manufacturing method of claim 5, wherein the step of providing a chromogenic material, and forming a color film onto the third pattern structure is achieved by a method selected from the group of lithography, gravure, flexographic printing, screen printing and physical vapor deposition.

8. The multi-layer 3D pattern manufacturing method of claim 7, wherein the chromogenic material used in the physical vapor deposition method is one selected from the group of nitrate, carbide, carbonitride, oxide and nitrogen oxide.

9. A manufacturing apparatus used in a multi-layer 3D pattern manufacturing method according to claim 5, comprising:
a carrying platform, having a ridge formed separately on both lateral edges of the carrying platform and corresponding to the thickness of the substrate and the sub-film, and the two ridges being disposed parallel to each other to form a rail, and the substrate and the sub-film being disposed between the rail;
a heating module, installed in the carrying platform, for heating the substrate to 60-300 degrees Celsius;
a transfer printing module, installed at the top of the carrying platform, and having a roller and an UV illuminating unit, and a predetermined interval being form between the roller and the rail for accommodating the substrate and the sub-film, and the roller uniformly pressing the sub-film on the substrate for transcribing and printing;
a substrate fixture, having a fixed clamping unit and a movable clamping unit, and the fixed clamping unit being installed on a side of the carrying platform, and the movable clamping unit being installed on the other side of the carrying platform, and the fixed clamping unit and the movable clamping unit respectively clamping both ends of the demolded sub-film; and
an ejector, installed between the carrying platform and the movable clamping unit, such that when the roller presses the sub-film down to the substrate, the movable clamping unit is driven by the sub-film to move downwardly, and when the ejector moves upward, the movable clamping unit is driven by the sub-film to move upwardly and in a direction towards the carrying platform.

10. The manufacturing apparatus of claim 9, wherein the predetermined interval is achieved by adjusting the height of the pair of ridges and the downward pressure of the roller to improve the transcription rate.
